(19) United States
(12) Patent Application Publication
(10) Pub. No.: US 2009/0212621 A1
(43) Pub. Date: Aug. 27, 2009

(54) Electrohydraulic Braking System Comprising Vehicle Dynamics Control

(76) Inventors: Peter Drott, Frankfurt (DE); Harald König, Ober-Mörlen (DE); Udo Jungmann, Mörfelden (DE); Andreas Bischoff, Bad Vilbel (DE)

Correspondence Address: RATNERPRESTIA, P.O. BOX 980, VALLEY FORGE, PA, 19482, US

(21) Appl. No.: 11/886,889

(22) PCT Filed: Mar. 23, 2006
(86) PCT No.: PCT/EP2006/060985

§ 371 Date: Dec. 3, 2008

(30) Foreign Application Priority Data
Mar. 23, 2005 (DE) 10 2005 013 392.4
Oct. 13, 2005 (DE) 10 2005 049 395.5
Mar. 22, 2006 (DE) 0 2006 013.626.8

(51) Int. Cl. B60T 11/20

(52) U.S. Cl. 303/14

(57) ABSTRACT

An electrohydraulic brake system with driving dynamics control comprising a master cylinder that is operable by a brake pedal and includes at least one piston, which is displaceably arranged in a housing of the master cylinder and delimits a hydraulic pressure chamber together with the housing, the pressure chamber being connectable to an unpressurized pressure fluid reservoir by way of a pressure fluid reservoir connection and a pressure fluid channel and to wheel brakes to by way of an outlet, with a pressure fluid supply device supplying pressure fluid from the pressure fluid reservoir in the direction of the wheel brakes in the case of driving dynamics control.

In order to achieve a short reaction time of the driving dynamics control and, simultaneously, a short lost travel of the master cylinder, a bypass channel is interposed between the pressure fluid reservoir connection and the outlet of the master cylinder, and a valve is arranged in the bypass channel, which allows pressure fluid flow from the pressure fluid reservoir through the bypass channel to the pressure fluid supply device and prevents pressure fluid flow in the opposite direction.

This application is the U.S. national phase application of PCT International Application No. PCT/EP2006/060985, filed Mar. 23, 2006, which claims priority to German Patent Application No. DE102005013392.4, filed Mar. 23, 2005, German Patent Application No. DE102005049395.5, filed Oct. 13, 2005, and German Patent Application No. DE102006013626.8, filed Mar. 22, 2006, the contents of such applications being incorporated by reference herein.

### BACKGROUND OF THE INVENTION

1. Field of the Invention

The present invention relates to an electrohydraulic brake system with driving dynamics control comprising a master cylinder that is operable by means of a brake pedal and includes at least one piston, which is displaceably arranged in a housing of the master cylinder and delimits a hydraulic pressure chamber together with the housing, the pressure chamber being connectable to an unpressurized pressure fluid reservoir by way of a pressure fluid reservoir connection and a pressure fluid channel and to wheel brakes by way of an outlet, with a pressure fluid supply device supplying pressure fluid from the pressure fluid reservoir in the direction of the wheel brakes in the case of driving dynamics control.

2. Description of the Related Art

Electrohydraulic brake systems of this type equipped with driving dynamics control, such as BASR (brake intervention traction slip control system), ARP (Active Rollover Protection) or ESP (Electronic Stability Program) with the included sub-functions ABS and TCS are principally known in the art. It may be necessary in a TCS or ESP intervention, with the master cylinder non-activated or activated, to replenish pressure fluid out of the pressure fluid reservoir in the direction of the wheel brakes, what is done by means of the pressure fluid supply device, whose inlet is optionally connectable to the pressure chambers of the master cylinder or to the wheel brakes in order to supply fluid in the direction of the wheel brakes or in the direction of the master cylinder (return principle).

In a master cylinder disclosed in DE 101 20 913 A1, for example, the pressure fluid is aspirated to this end out of the pressure fluid reservoir through the pressure fluid channel, a supply chamber, transverse bores in the piston and the pressure chamber in a TCS intervention, in the non-activated condition of the master cylinder. In an ESP intervention in the activated condition of the master cylinder, the replenishment is carried out additionally by fluid overflow at an outside sealing lip of a sealing cup. In order to supply sufficient pressure fluid to the pressure fluid supply device at a quick rate in a TCS or ESP intervention, in particular when the master cylinder adopts its non-activated position, and in order to thereby minimize the reaction time of driving dynamics control, it is necessary in prior art brake systems to keep the throttling resistance of the transverse bores as low as possible. An additional objective is to minimize the lost travel of the master cylinder in order that brake pressure can be built up in the wheel brakes as quickly as possible. However, these requirement always necessitate a compromise between throttling resistance and lost travel.

### SUMMARY OF THE INVENTION

In view of the above, an object of the invention is to provide an electrohydraulic brake system with driving dynamics control, which has a short reaction time of the driving dynamics control and, in addition, a short lost travel of the master cylinder.

According to the invention, this object is achieved in that a bypass channel is interposed between the pressure fluid reservoir connection and the outlet of the master cylinder, and a valve is arranged in the bypass channel, which allows pressure fluid flow from the pressure fluid reservoir through the bypass channel to the pressure fluid supply device and prevents pressure fluid flow in the opposite direction. As a result, the transverse bores designed in the piston can have a minimum possible cross-section irrespective of the reaction time of the driving dynamics control, what minimizes the lost travel of the master cylinder. Likewise, it is hence advantageous that the same master cylinder can be used for brake systems with different requirements as regards the fluid replenishment in the driving dynamics control case, hence, obviating the need for special components for a flow-optimized master cylinder.

The pressure fluid channel is preferably designed between the pressure fluid reservoir connection and an inlet of the master cylinder. According to a favorable embodiment, the pressure fluid channel and the bypass channel are integrated into a wall of the housing, and the pressure fluid reservoir connection is configured as a separate component, which can be fastened to the housing of the master cylinder.

According to another favorable embodiment, the pressure fluid channel, the bypass channel, and the pressure fluid reservoir connection are designed as a separate, one-piece component, which can be fastened to the housing of the master cylinder and can thus be provided as a pre-assembled unit.

In still another favorable embodiment of the invention, the pressure fluid channel, the bypass channel, and the pressure fluid reservoir connection are integrated in a wall of the housing. The advantage resulting therefrom is that only the assembly of the valve is required as an additional working step in the manufacture of the master cylinder.

It is considered as another shortcoming in the prior art master cylinder according to DE 101 20 913 A1 that, with a quick release of the applied brake, i.e. in a quick return movement of the piston in opposition to the actuating direction, pressure fluid flows abruptly from the pressure fluid reservoir into the pressure chamber in the moment when the transverse bores leave the area of a sealing cup, since vacuum or pressure below atmospheric pressure develops in the pressure chamber due to the return movement of the piston. The abrupt inflow of the pressure fluid into the pressure chamber can cause disturbing noise (cavitation bang). Therefore, a favorable embodiment of the invention provides for the bypass channel to open into the pressure chamber so that pressure fluid flow occurs from the pressure fluid reservoir through the bypass channel, the pressure chamber, and the outlet of the pressure fluid supply device in a driving dynamics control case. To this end, the valve must be designed in such a fashion that it opens at a defined pressure below atmospheric pressure, thus, avoiding an abrupt inflow of pressure fluid, i.e. a cavitation bang.

Ease of manufacture of the bypass channel is achieved in that the bypass channel, starting from the pressure fluid reservoir connection, extends directly to the pressure chamber. Further, no mounting space or only a small mounting space must be provided for the bypass channel and the valve.

In another advantageous embodiment, the bypass channel extends from the pressure fluid channel to the pressure chamber, and the housing includes an additional dome into which the valve is introduced. This allows mounting the valve in a simple fashion. Preferably, the bypass channel comprises a branch bore branching from the pressure fluid channel and a transverse bore, with the branch bore extending in parallel to a longitudinal axis of the master cylinder, while the transverse bore is positioned transversely to the longitudinal axis.

To prevent contaminants from entering the pressure chamber through the pressure fluid channel, according to a favorable embodiment, the pressure fluid channel has a first, large diameter in the area between the pressure fluid reservoir connection and the branching of the branch bore, and a second, small diameter in the area between the branch bore and the pressure chamber.

A combination of two mentioned embodiments of the invention provides that in a first brake circuit, the bypass channel extends from the pressure fluid reservoir connection directly to the pressure chamber, and that the bypass channel extends from the pressure fluid channel to the pressure chamber in a second brake circuit. Thus, the mentioned advantages are achieved for both brake circuits.

Preferably, the valve is configured as a spring-loaded or diaphragm-controlled non-return valve. This fact safeguards a conventional closing behavior of the master cylinder, since after a pressure fluid demand by way of the pressure fluid supply device, return of the pressure fluid to the pressure fluid reservoir is prevented at once. A disc in the valve can serve as a filter and/or restrictor.

Further details, features and advantages of the invention can be taken from the subsequent description of two embodiments making reference to the accompanying schematic drawings.

### BRIEF DESCRIPTION OF THE DRAWINGS

In the accompanying drawings:

FIG. 1 shows the design of a prior art electrohydraulic brake system with driving dynamics control;

FIG. 2 is a longitudinal cross-sectional view of a master cylinder of a first embodiment of a brake system of the invention in the non-activated position;

FIG. 3 is a longitudinal cross-sectional view of the master cylinder of the first embodiment of a brake system of the invention according to FIG. 2 in the activated position;

FIG. 4 is a longitudinal cross-sectional view of a master cylinder of a second embodiment of a brake system of the invention in the non-activated position;

FIG. 5 is a cross-sectional view of a master cylinder of a third embodiment of a brake system of the invention;

FIG. 6 is a longitudinal cross-sectional view of a master cylinder of a fourth embodiment of a brake system of the invention in the non-activated position;

FIG. 7 is a view of a diaphragm-controlled non-return valve in the first brake circuit, and

FIG. 8 is a view of a diaphragm-controlled non-return valve in the second brake circuit.

### DETAILED DESCRIPTION OF THE PREFERRED EMBODIMENTS

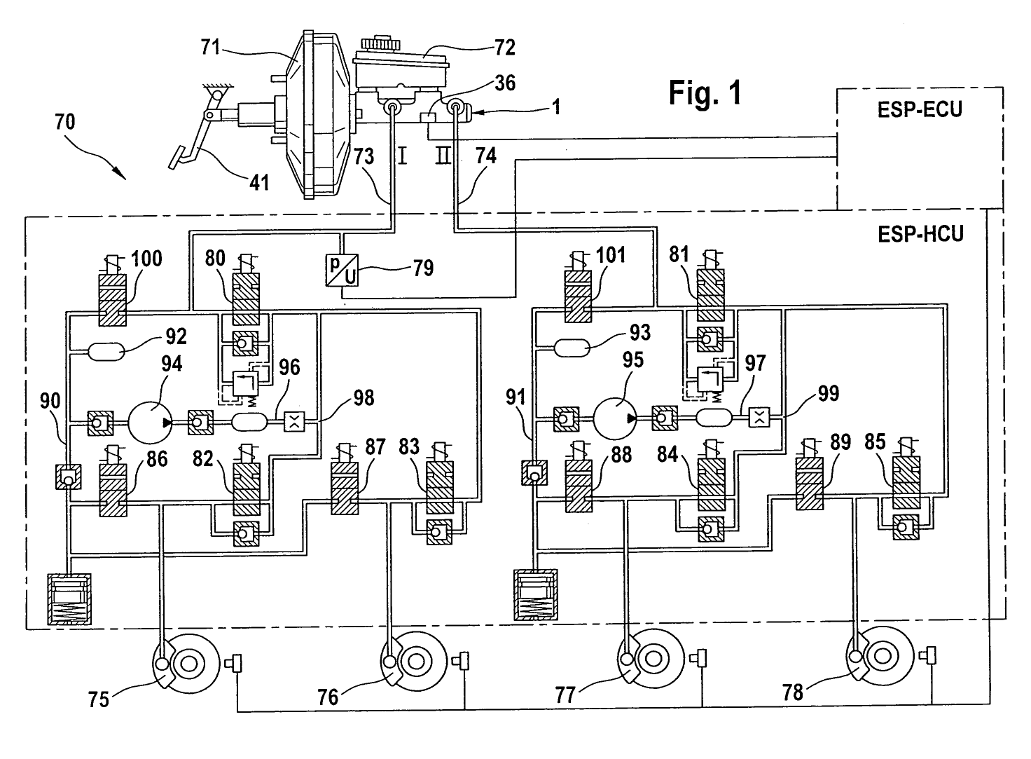

FIG. 1 serves to explain a per se known electrohydraulic brake system 70, which is equipped herein with a driving dynamics control system (ESP) as an example. The brake system 70 comprises a brake device with a pneumatic brake booster 71, a pedal-operated master cylinder 1 with an unpressurized pressure fluid supply reservoir 72, and non-illustrated pressure chambers 4, 5 of the master cylinder 1 are connected to wheel brakes 75-78 by way of brake lines 73, 74. Wheel brakes 75-78 are combined in pairs in so-called brake circuits I, II. Regarding the brake circuits I, II, the so-called diagonal circuit allotment grouping diagonally opposite wheel brakes of the front axle and the rear axle of a vehicle has become generally accepted, while principally a different circuit allotment such as the so-called black/while allotment is also possible, combining the wheel brakes of one axle in a pair.

A pressure sensor 79 at the brake line 73 is used to sense a pressure introduced by the driver, the brake line connecting the pressure chamber 4 to the wheel brakes 75, 76 of brake circuit I. Each brake line 73, 74 includes a serial arrangement of electromagnetic separating valves 80, 81 and each one inlet valve 82-85 and each one outlet valve 86-89 for each wheel brake 75-78. The two wheel brakes 75, 76; 77, 78 of each one brake circuit I, II are connected to a return line 90, 91, with the outlet valve 86-89 being respectively inserted into the line branches per wheel brake 75-78. Connected downstream of the outlet valves 86-89 in each return line 90, 91 is a low-pressure accumulator 92, 93 that communicates with an inlet of an electromotively driven pressure fluid supply device 94, 95, which is e.g. configured as a pump and feeds the two brake circuits I, II. There is a hydraulic connection between an outlet of each pressure fluid supply device 94, 95 and the associated brake circuit I, II by way of pressure channel 96, 97 and a branch line 98, 99, and the pressure increase in the wheel brakes 75-78 is controllable by way of the inlet valves 82-85. This renders it possible to introduce pressure into the wheel brakes 75-78 by way of the pressure fluid supply devices 94, 95 for driving stability intervention purposes or for braking operations, without the need for a central high-pressure accumulator such as in electrohydraulic brake systems.

In order to permit a change between ABS return delivery operation (supply direction in the direction of master brake cylinder 1) and TCS or ESP driving dynamics control operation (supply direction in the direction of the wheel brakes) by means of the pressure fluid supply devices 94, 95, a change-over valve 100, 101 is integrated in the suction branch line of each pressure fluid supply device 94, 95, which valve is able to establish a pressure fluid connection between the master cylinder 1 and the inlet of the pressure fluid supply devices 94, 95 when the driving dynamics control system is active.

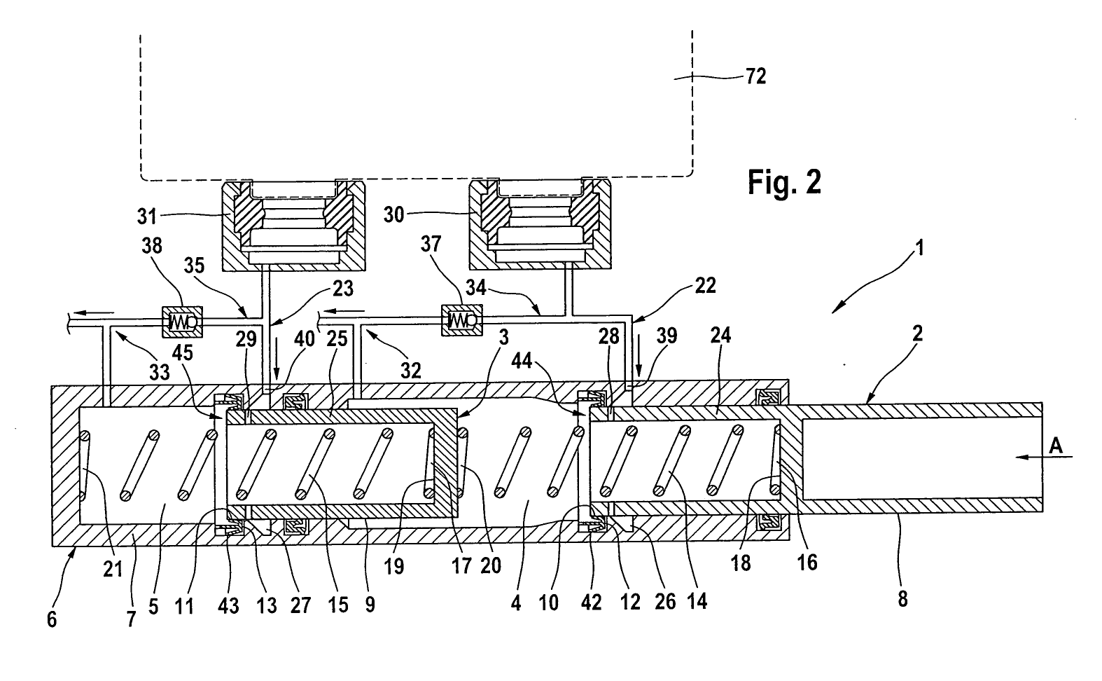

FIG. 2 shows a master cylinder 1 of a first embodiment of an electrohydraulic brake system of the invention including driving dynamics control such as ESP. The mode of operation of a master cylinder 1 of this type is principally known in the art so that only the features that are essential to the invention will be described.

The master cylinder 1 with a first and a second piston 2, 3 for a first and a second pressure chamber 4, 5 is operable by means of a brake pedal 41 illustrated in FIG. 1, which is connected indirectly or directly to the first piston 2, with the pistons 2, 3 being displaceably arranged inside a housing 6 of the master cylinder 1 for the pressure fluid supply of the wheel brakes 75 to 78.

The master cylinder 1 is of the so-called plunger type with stationary sealing cups 12, 13 arranged in a wall 7 of housing 6 and abutting on a piston wall 8, 9 with an inside sealing lip 10, 11 for sealing the pressure chambers 4, 5. Fluid can flow over outside sealing lips 42, 43 of the sealing cups 12, 13 in the direction of the wheel brake 75-78 if a pressure gradient is set between the pressure fluid supply reservoir 72, shown in dotted line, and wheel brakes 75-78. For the non-activated operating condition, a pressure-compensating connection is further established between the two pressure chambers 4, 5 by way of the pressure fluid reservoir 72 so that a general pressure balance exists also between the two brake circuits I, II for this non-activated operating condition.

Associated with each of the pistons 2, 3 is a resetting spring 14, 15, which is supported with one end 16, 17 on a piston bottom 18, 19, while with its other end 20, 21 it is supported indirectly or directly on the second piston 3 or on the housing 6. In the event of piston displacement in an actuating direction A, the resetting spring 14, 15, which is arranged at least partly in a bowl-shaped wall 24, 25 of the piston 2, 3, is compressed, and it is expanded for piston resetting purposes.

The master cylinder 1 is shown only in a highly schematic view, the resetting spring 14, 15 being supported on the second piston 3 or on the housing 6, respectively.

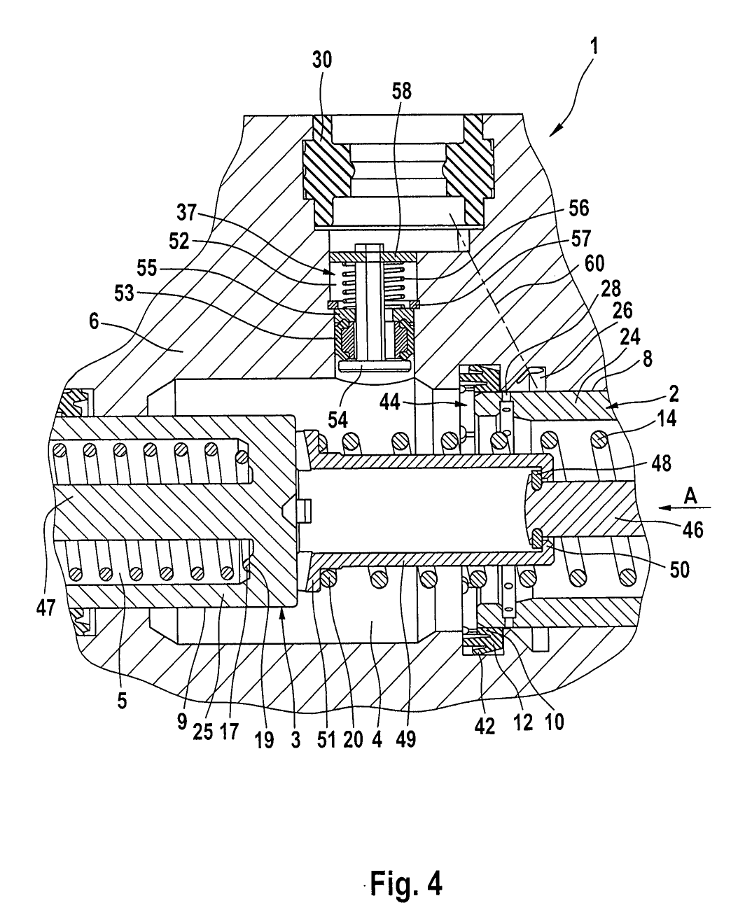

To improve the assembly, it is also feasible within the limits of the invention, as indicated in the second embodiment according to FIG. 4, to provide the pistons 2, 3 together with the resetting springs 14, 15 as a pre-assembled unit. For example, a cylindrical peg 46, 47 illustrated in FIG. 4 can be provided for this purpose, which, starting from the piston bottom 18, 19, extends centrically through the bowl-shaped wall 24, 25 of the pistons 2, 3 and ends before its axial exit from the wall 24, 25. This end can be provided with a stop 48 for a sleeve 49 that cooperates with a collar 50 in such a fashion that the sleeve 49 can be telescoped within limits in relation to the peg 46, 47. Upon actuation, the sleeve 49 with resetting spring 14, 15 can be urged into the interior of the piston. The stop 48 for the sleeve 49 can be an annular washer, which is riveted, in particular wobble-riveted, to the peg 46, 47. The other end of sleeve 49 can have a plate-type collar 51 for abutment of the resetting spring 14, 15.

In the non-activated condition of the master cylinder 1 as shown, the pressure chambers 4, 5 communicate with non-illustrated connecting sockets of the pressure fluid reservoir 72 by way of a pressure fluid channel 22, 23 and a supply chamber 26, 27 in the housing 6 as well as through transverse bores 28, 29 in the bowl-shaped wall 24, 25, that is arranged at a side 44, 45 of the first and the second piston 3, 4.

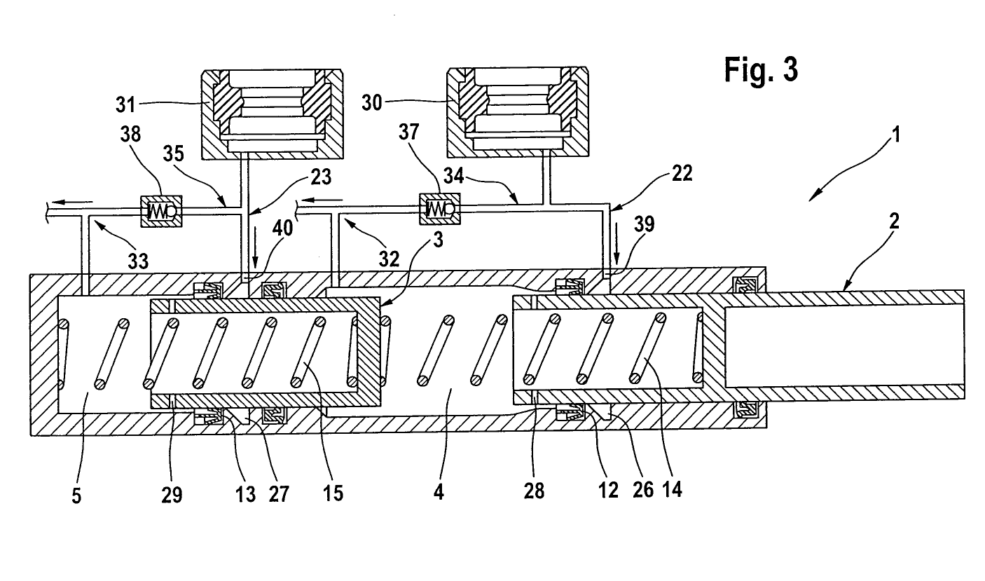

The first piston 2 is displaced in the actuating direction A to actuate the master cylinder 1. As this occurs, the movement of the first piston 2 is transmitted to the second piston 3 by way of the resetting spring 14. As soon as the transverse bores 28, 29 are disposed in the area of the sealing cup 12, 13, the so-called lost travel of the master cylinder 1 is covered, since pressure fluid cannot propagate from the supply chambers 26, 27 through the transverse bores 28,29 into the pressure chambers 4, 5. The connection between the pressure chambers 4, 5 and the pressure fluid reservoir 72 is interrupted, and pressure is built up in the pressure chambers 4, 5. An activated position of the master cylinder 1 is represented in FIG. 3.

It can be necessary in a TCS or ESP control intervention to replenish pressure fluid from the pressure fluid reservoir in the direction of the wheel brakes, with the pistons 2, 3 non-activated or activated, what is preferably done by means of the pressure fluid supply device 94, 95, the inlet of which is optionally connectable to the pressure chambers 4, 5 of the master cylinder 1 or to the wheel brakes 75-78, in order to deliver fluid in the direction of the wheel brakes 75-78 or in the direction of the master cylinder 1 (return principle). To this end, the pressure fluid is replenished out of the pressure fluid reservoir 72 through a bypass channel 34, 35 in the direction of the wheel brakes 75-78 in a TCS or ESP control intervention.

As can be seen in FIG. 2, the bypass channel 34, 35 is positioned between a pressure fluid reservoir connection 30, 31 and an outlet 32, 33 of the master cylinder 1, and a valve 37, 38 is provided in this arrangement, which allows pressure fluid flow from the pressure fluid reservoir 72 through the bypass channel 34, 35 to the pressure fluid supply device 94, 95 in a case of control and prevents pressure fluid flow in the opposite direction. This ensures a conventional closing behavior of the master cylinder 1, since after a pressure fluid demand by way of the pressure fluid supply device 94, 95, return of the pressure fluid to the pressure fluid reservoir 72 is immediately stopped. Pressure fluid that is returned through the pressure fluid supply device 94, 95 in the direction of the master cylinder 1 is, thus, conducted via the pressure chamber 4, 5 into the pressure fluid reservoir 72 like in prior art brake systems.

Consequently, the replenishment of the pressure fluid supply device 94, 95 through the bypass channel 34, 35 allows improving the reaction time of the driving dynamics control system, since the replenishment is given irrespective of the throttling resistance of the components of the master cylinder 1.

Valve 37, 38 is provided as a spring-loaded non-return valve, which can be configured as a diaphragm-type, ball valve or plug valve. However, all types of construction of a non-return valve are principally possible.

As can be seen from the illustration of the master cylinder 1 in FIG. 2 (only represented), the pressure fluid channel 22, 23 is designed between an inlet 39, 40 of the master cylinder 1 and the pressure fluid reservoir connection 30, 31.

Most various embodiments of the master cylinder 1 are feasible within the limits of the invention. Thus, it is possible, on the one hand, to integrate the pressure fluid channel 22, 23, the bypass channel 34, 35, as well as the pressure fluid reservoir connection 30, 31 into the wall 7 of the housing 6, e.g. by way of casting it on. The result is that only the assembly of the valve 37, 38 would become necessary as an additional working step in the manufacture of the master cylinder 1. On the other hand, it is also possible to integrate only the bypass channel 34, 35 and the pressure fluid channel 22, 23 into the wall 7 of the housing 6, e.g. by casting it on, and to configure the pressure fluid reservoir connection 30, 31 as a separate component, which can be fastened at the housing 6 of the master cylinder 1. It is also feasible to provide the bypass channel 34, 35, the pressure fluid channel 22, 23, and the pressure fluid reservoir connection 30, 31 as a separate, integral component, which can be secured at the housing 6 of the master cylinder 1.

Furthermore, it is possible in all embodiments that the master cylinder 1 includes a device for detecting brake application, which comprises a magnet as a signal generator and a sensor element 36 shown in FIG. 1, and by means of which a reliable monitoring of a piston 2, 3 is rendered possible even during a driving dynamics control operation or an ABS intervention due to closed separating valves 80, 81. This allows detecting the driver's request over the entire actuating travel and optimizing vehicle control operations.

It becomes obvious from FIG. 3 that excess pressure is prevailing in the pressure chambers 4, 5 and at the outlet 32, 33 in an activated condition of the master cylinder 1, and the valve 37, 38 does not allow pressure fluid flow from the outlet 32, 33 through the bypass channel 34, 35. The inlet 39, 40 and the pressure fluid channel 22, 23 are unpressurized in this arrangement.

The master cylinder 1 exhibits a good replenishment behavior also in the activated condition, what is due to the replenishment of the pressure fluid through the bypass channel 34, 35, because the replenishment is provided irrespective of the throttling resistance of the components of the master cylinder 1. Hence, the replenishment of the pressure fluid due to overflow of the outside sealing lip 42, 43 of the sealing cup 12, 13 is omitted.

This allows reducing also the spring cushioning and, thus, the efficiency of the master cylinder 1, since it is no longer required to overcome a vacuum during replenishment, which is applied to the sealing cup 12, 13 until the outside sealing lip 42, 43 turns about.

A second embodiment of a master cylinder 1 of a brake system of the invention, in which a pressure fluid channel 60, indicated only by a line, a bypass channel 52, and the pressure fluid reservoir connection 30 are integrated in the housing 6, is illustrated in FIG. 4, showing a longitudinal cross-sectional view of the master cylinder 1 in the non-activated position. This embodiment differs from the first embodiment only in the arrangement of the bypass channel 52 so that the above statements equally apply to this embodiment. Like components have been assigned like reference numerals and are not described repeatedly.

It becomes apparent from FIG. 4 that the master cylinder 1 of the second embodiment has a bypass channel 52, which extends from the pressure fluid reservoir connection 30 directly to the pressure chamber and ends therein so that, in the driving dynamics control case, there is a pressure fluid replenishment from the pressure fluid reservoir 72 or the pressure fluid reservoir connection 30, respectively, through the bypass channel 52, the pressure chamber 4 of the first brake circuit I, and the non-illustrated outlet 32 to the pressure fluid supply device 94.

The bypass channel 52 and the pressure fluid channel 60 can be provided during manufacture of the housing 6, or they can be provided in the housing 6 retroactively e.g. in a metal-cutting process.

Besides, this embodiment is advantageous in that, with a quick release of the brake application, disturbing noise (cavitation bang) can be avoided. This bang develops in the event of a fast return movement of the piston 2 in opposition to the actuating direction A, when pressure fluid flows abruptly from the pressure fluid reservoir 72 into the pressure chamber 4 in the moment when the transverse bores 28 leave the area of the sealing cup 12, and when a vacuum or pressure below atmospheric pressure develops in the pressure chamber 4 due to the return movement of the piston 2. For this purpose, the valve 37 must be designed in such a manner that it opens at a defined pressure below atmospheric pressure, whereby an abrupt inflow of pressure fluid, i.e. a cavitation bang, can be prevented.

Valve 37 is provided as a spring-loaded non-return valve in this embodiment and includes a valve seat 53, a valve pin 54, a valve accommodation 55, and a valve spring 56. The attachment in the bypass channel 52 is executed by a securing element 57 fixing the valve accommodation 55 in the bypass channel 52. Furthermore, a disc 58 is arranged, against which the valve spring 56 bears and which can serve as a filter.

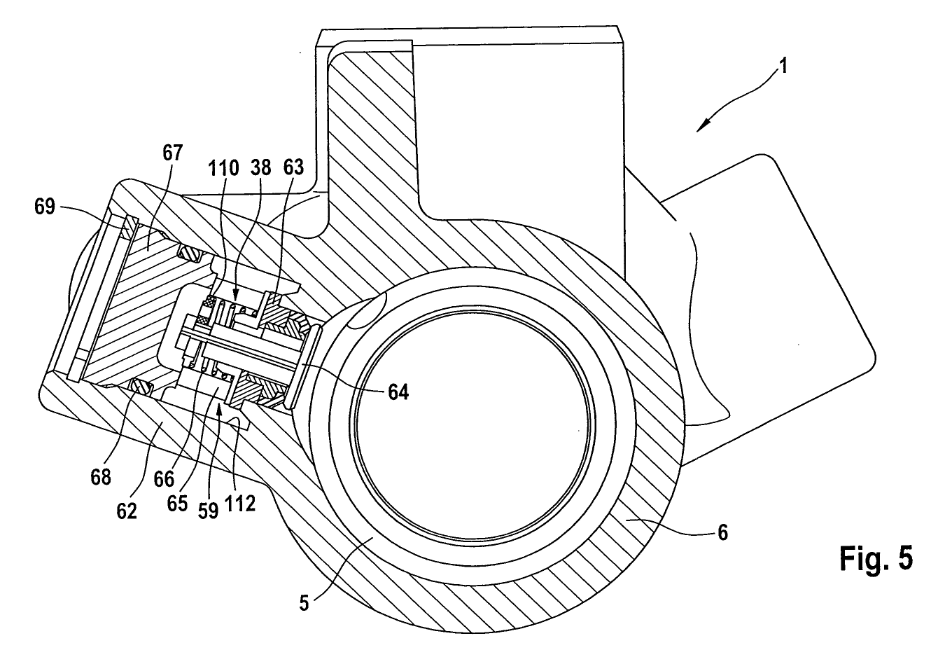

FIG. 5 shows a cross-sectional view of a master cylinder 1 in the area of the pressure chamber 5 of the second brake circuit II of a third embodiment. As is obvious, the master cylinder 1 has an additional dome 62, into which the valve 38 designed as a spring-loaded non-return valve is introduced. Valve 38 has a similar design as valve 37 according to FIG. 4 and comprises a valve seat 63, a valve pin 64, a valve accommodation 65, and a valve spring 66. A closing cap 67 is fastened and sealed in the dome 62 by means of an annular sealing element 68 and a securing element 69 and safeguards the position of the valve 38. A disc 110 serves as a filter, on the one hand, and can also be provided as a restrictor for the pressure fluid flow limitation, on the other hand.

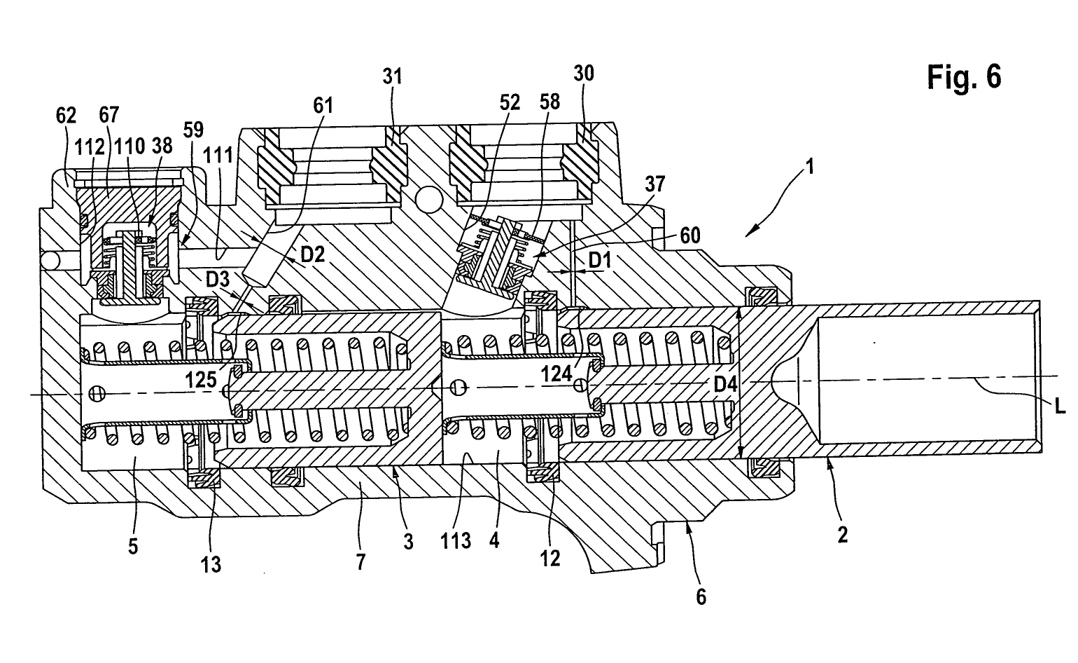

The bypass channel 59 and a pressure fluid channel 61 of this embodiment are shown in detail with respect to FIG. 6.

FIG. 6 is a longitudinal cross-sectional view of a master cylinder in the non-activated position in a fourth embodiment of a brake system of the invention. It is a combination of embodiments according to FIGS. 4 and 5.

As is obvious, the bypass channel 52 with the non-return valve 37 is provided in brake circuit I according to FIG. 4. The pressure fluid channel 60 has a very small diameter D1 of roughly 0.7 mm. Contaminants out of the pressure fluid reservoir 72 are thereby prevented from being sucked into the pressure chamber 4. Further, a so-called PFO function (Pedal Feel Optimizer) can be achieved thereby, that means a small lost travel and thus a quick response of the brake system, because the pressure fluid channel 60, which is restricted by the very small diameter D1, prevents a rapid discharge of the pressure fluid into the pressure fluid reservoir 72 and, hence, minimizes the loss in volume until the closing point is reached.

A bypass channel 59 and a non-return valve 38 are provided in the second brake circuit II according to FIG. 5. As can be seen in FIG. 6, the bypass channel 59 branches from the pressure fluid channel 61 and opens into the pressure chamber 5. Moreover, the bypass channel 59 is composed of a first branch bore 111, which is arranged in the housing 6 in parallel to a longitudinal axis L of the master cylinder 1, and a second transverse bore 112, which is provided transversely to the longitudinal axis L, with the valve 38 being positioned in the transverse bore 112. The pressure fluid channel 61 has a first, large diameter D2 in the area between the pressure fluid reservoir connection 31 and the branch bore 111. In the area between the branching of the branch bore 111 and the pressure chamber 5, a second, small diameter D3 is provided, which exhibits roughly 0.7 mm similarly to the diameter D1 of the pressure fluid channel 60.

As can be seen in addition, it is feasible on account of the bypass channels 52, 59 to simplify the design of the housing 6 and to omit the transverse bores 28, 29 of the pistons 2, 3 shown in FIG. 2 and FIG. 4. Thus, the housing 6 can be simplified by arranging an almost uniform diameter 4 in a main bore 113 of the master cylinder 1. Furthermore, free spaces for annular supply chambers 26, 27 illustrated in FIGS. 2 and 4 and additional supporting webs between the supply chambers 26, 27 and the sealing cups 12, 13 can be omitted or considerably reduced, which were necessary due to the replenishment action by way of the sealing cups 12, 13. It can be seen in FIG. 6 that small recesses 124, 125 are provided only in the area where the pressure fluid channels 60, 61 open into the pressure chambers 4, 5.

Principally, the bypass channels 34, 35, 52, 59 described according to the embodiments can be provided in only one brake circuit or in both brake circuits I, II. It is also possible then to position the non-return valve 37 in the first brake circuit I in an additional dome and to design the bypass channel similarly to the bypass channel 59.

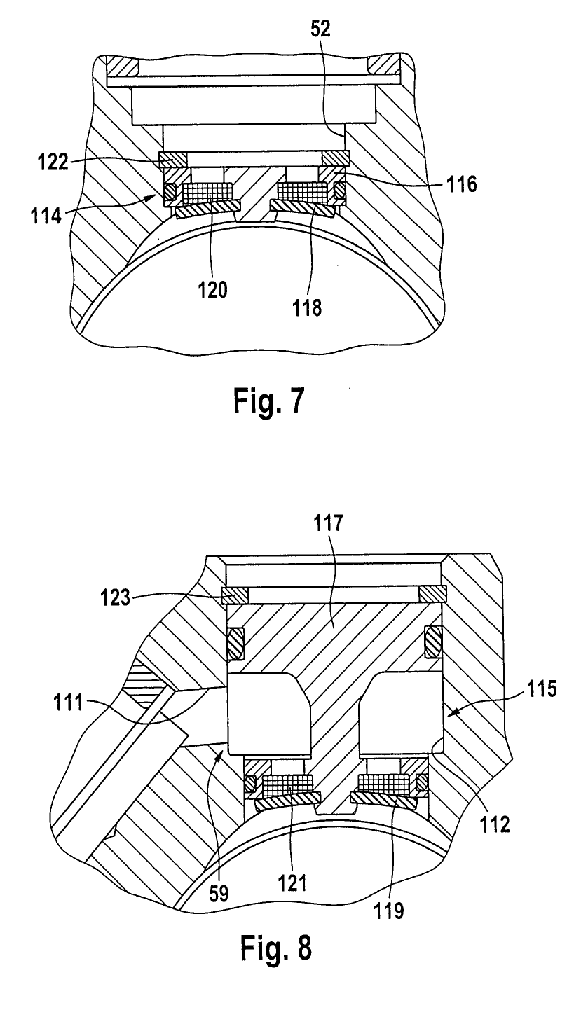

FIGS. 7 and 8 depict diaphragm-controlled non-return valves 114, 115, which can be provided as valves 37, 38 in the bypass channels 52, 59, for example. As can be seen, the valves 114, 115 include in each case a valve member 116, 117 and a diaphragm 118, 119. A slide 120, 121 serves as a filter or can be provided as a throttle. The valves 114, 115 are secured in the bypass channels 52, 59 by means of annular securing elements 122, 123.

As becomes apparent from FIG. 8, there is no need for a closing cap in this valve configuration because the valve member 117 allows sealing and securing the valve 115.

1-14. (canceled)

15. Electrohydraulic brake system with driving dynamics control comprising a master cylinder that is operable by means of a brake pedal and includes at least one piston, which is displaceably arranged in a housing of the master cylinder and delimits a hydraulic pressure chamber together with the housing, the pressure chamber being connectable to an unpressurized pressure fluid reservoir by way of a pressure fluid reservoir connection and a pressure fluid channel and to wheel brakes by way of an outlet, with a pressure fluid supply device supplying pressure fluid from the pressure fluid reservoir in the direction of the wheel brakes in the case of driving dynamics control,
wherein a bypass channel extends between the pressure fluid reservoir connection and the outlet of the master cylinder, and a valve is arranged in the bypass channel and allows pressure fluid flow from the pressure fluid reservoir through the bypass channel to the pressure fluid supply device and prevents pressure fluid flow in the opposite direction.

16. Electrohydraulic brake system as claimed in claim 15,
wherein the pressure fluid channel extends between the pressure fluid reservoir connection and an inlet of the master cylinder.

17. Electrohydraulic brake system as claimed in claim 16,
wherein the pressure fluid channel and the bypass channel are integrated into a wall of the housing, and the pressure fluid reservoir connection is configured as a separate component fastenable to the housing of the master cylinder.

18. Electrohydraulic brake system as claimed in claim 16,
wherein the pressure fluid channel, the bypass channel, and the pressure fluid reservoir connection are designed as a separate, one-piece component fastenable to the housing of the master cylinder.

19. Electrohydraulic brake system as claimed in claim 16,
wherein the pressure fluid channel, the bypass channel, and the pressure fluid reservoir connection are integrated in a wall of the housing.

20. Electrohydraulic brake system as claimed in claim 19,
wherein the bypass channel opens into the pressure chamber so that, in a case of driving dynamics control, pressure fluid flow takes place from the pressure fluid reservoir via the bypass channel, the pressure chamber, and the outlet to the pressure fluid supply device.

21. Electrohydraulic brake system as claimed in claim 20,
wherein the bypass channel, starting from the pressure fluid reservoir connection, extends directly to the pressure chamber.

22. Electrohydraulic brake system as claimed in claim 20,
wherein the bypass channel extends from the pressure fluid channel to the pressure chamber, and the housing includes a dome into which the valve is introduced.

23. Electrohydraulic brake system as claimed in claim 22,
wherein the bypass channel comprises a branch bore branching from the pressure fluid channel and a transverse bore, with the branch bore extending in parallel to a longitudinal axis (L) of the master cylinder, while the transverse bore is positioned transversely to the longitudinal axis (L).

24. Electrohydraulic brake system as claimed in claim 23,
wherein the pressure fluid channel has a first, large diameter in the area between the pressure fluid reservoir connection and the branching of the branch bore and a second, small diameter in the area between the branch bore and the pressure chamber.

25. Electrohydraulic brake system as claimed in claim 23,
wherein in a first brake circuit, the bypass channel extends from the pressure fluid reservoir connection directly to the pressure chamber, and in a second brake circuit, the bypass channel extends from the pressure fluid channel to the pressure chamber.

26 Electrohydraulic brake system as claimed in claim 15,
wherein the valve is configured as a spring-loaded non-return valve.

27. Electrohydraulic brake system as claimed in claim 15,
wherein the valve is configured as a diaphragm-controlled non-return valve.

28. Electrohydraulic brake system as claimed in any one of claims 26,
wherein the valve includes a disc as a filter, a restrictor, or a filter and a restrictor.
